(19) United States
(12) Patent Application Publication
(10) Pub. No.: US 2004/0101459 A1
(43) Pub. Date: May 27, 2004

(54) Method for neutralising odours in the air in a non-toxic manner

(76) Inventor: Jorg Peter Schur, Wegberg-Dalheim (DE)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/250,897

(22) PCT Filed: Jan. 4, 2002
(86) PCT No.: PCT/EP02/00040

(30) Foreign Application Priority Data
Jan. 9, 2001 (DE) 10100595.4

(51) Int. Cl. B01D 47/06; C01B 3/00

(52) U.S. Cl. 423/210

(57) ABSTRACT

The invention relates to a method for neutralising odours in the air in a non-toxic manner. According to the inventive method, a special odour-masking composition is distributed or atomised. Said composition contains at least one odour-masking constituent (A) selected from terpenes, maize starch, manganese salts, ethereal oils and polyvinylpryrrolidone. The invention also relates to odour-masking compositions used in the method, and the use of said compositions for reducing odours.

The present invention relates to a method for non-toxic odor neutralization, comprising the distributing or atomizing of a specific odor-masking composition, to odor-masking compositions suitable for this purpose, and the use of these compositions for odor reduction.

Offensive smells are a basic problem of today's high-technology civilization, especially when a sufficient aeration of the room environment is not possible. In addition, offensive smells in the ambient air are immediately related with a simultaneous germ load. Although the germ load of ambient air, which is a basic problem in private households and commercial office complexes as well as in plants of the producing trade, especially in food-processing plants, has been solved in the applications DE 19931185.4 and PCT/EP 00/06462 by distributing and atomizing an antimicrobial composition which contains one or more GRAS (generally recognized as safe) flavoring agents or their derivatives, and suitable devices for such distributing and atomizing have been described, for example, in PCT/EP 00/02992, the problem of the odor load, especially when these have once occurred, has not been solved therein. Currently, it can be controlled solely by a quick exchange of air, if at all. However, the effect achieved thereby is insufficient.

Surprisingly, it has now been found that the odor load in the ambient air can be significantly reduced by distributing/atomizing a special odor-masking composition. In addition, the subjective load of the ambient air or its bacterial load can be reduced by using functional flavor and fragrance components. Accordingly, the present application relates to

(1) a method for non-toxic odor-reduction, comprising the distributing or atomizing of an odor-masking composition in the environment to be treated, wherein said odor-masking composition contains at least one odor-masking component (A) selected from terpenes, corn starch, manganese salts, essential oils and polyvinylpyrrolidone, preferably at least polyvinylpyrrolidone;

(2) a preferred embodiment of the method defined in (1), wherein said odor-masking composition further contains a functional flavor component (B);

(3) a preferred embodiment of the method defined in (1) and (2), wherein said composition further contains a flavor component (C) selected from essential oils, flavoring agents and fragrances;

(4) an odor-masking composition, especially a composition for non-toxic odor reduction as defined in (1) to (3); and

(5) the use of the composition as defined in (4) for non-toxic odor reduction.

### FIGURES

The figures mentioned in the following show devices which can be employed in the odor-reduction methods according to the invention.

FIG. 1 shows an air DOA (disinfection of air) bubbler.

FIG. 2 shows a two-fluid nozzle system.

FIG. 3 shows a DOA evaporation system.

FIG. 4 shows a bubbler DOA device for disinfection within a package.

FIG. 5 shows a schematic lateral view of the device for enriching air.

FIG. 6 shows a device which corresponds to the device represented in FIG. 5 with a pressure generating means provided downstream.

FIG. 7 shows a DOA wick system with a heating plate and fan.

In the following, the components of the compositions according to the invention are described in more detail:

The preferred compound of the odor-masking component (A) is polyvinylpyrrolidone (polyvidone; poly(2-oxo-1-pyrolidinyl)ethylene; poly(1-vinyl-2-pyrrolidone); hereinafter sometimes briefly referred to as “PVP”), especially PVP having a molecular weight of from 10,000 to 60,000 g/mol, preferably from 30,000 to 50,000 g/mol. Particularly preferred is PVP having a molecular weight of about 40,000 g/mol, i.e., this is a PVP having a certain degree of cross-linking (i.e., a viscosity of from 15 to 25, preferably about 2 mPa·s at 20% by weight in water). The proportion of odor-masking component (A) in the odor-masking composition is preferably within a range of from 0.001 to 50% by weight, more preferably from 0.1 to 10% by weight.

According to embodiment (2), the odor-masking composition contains an additional functional flavor component (B), which preferably contains one or more of the following substances:

hexyl butyrate, octyl acetate, isobutyl isobutyrate, cis-3-hexene-1-yl acetate, γ-decalactone, ethyl caproate, butyl acetate, ethyl benzoate, ethyl butyrate, hexyl acetate, methyl caproate, phenylethyl alcohol, citronellol, undecyl aldehyde, benzylphenyl acetate, cinnamyl alcohol, eugenol, benzyl acetate, linalool, cis-jasmone, acetylmethyl anthranilate, cis-3-hexene-1-ol, cis-3-hexene-1-yl salicylate, methyl benzoate, methyl salicylate, geranyl acetate, cis-3-hexene-1-yl acetate, Litsea cubeba, orange oil, phenylpropyl alcohol and phenylethyl acetate.

Preferably, the proportion of the functional flavor component (B) is from 0.001 to 20% by weight, preferably from 0.1 to 5% by weight, of the odor-masking composition.

According to embodiment (3) of the invention, the odor-masking composition may further contain a flavor component (c) which is selected from essential oils, flavors and fragrances. The proportion of the flavor component (c) in the odor-masking composition is from 0.01 to 95% by weight, preferably from 0.1 to 80% by weight. In a particularly preferred embodiment, the flavor component (C) contains antimicrobial substances; preferably, it contains at least one GRAS (generally recognized as safe) flavoring agent. Of these, particularly preferred are those flavor components (C) which contain an aromatic GRAS flavor alcohol (such as benzyl alcohol, cinnamyl alcohol, α-methylbenzyl alcohol and anisalcohol, benzyl alcohol being preferred) or a GRAS polyphenol compound, orthose containing at least two GRAS flavoring agents. It has been found that especially those flavor components (C) which contain

(a) one or more GRAS flavor alcohols or their derivatives; and

(b) one or more flavoring agents selected from

(b1) polyphenol compounds; and

(b2) GRAS flavor acids or their derivatives

are particularly preferred.

The mentioned GRAS flavor alcohols of component (a) and the components (b) to (h) defined hereinbelow are recognized by the FDA authority as commercially safe for use in foods (GRAS=generally recognized as safe in food). The mentioned GRAS flavor alcohols and also the other GRAS flavoring agents defined below are the compounds mentioned in the FEMA/FDA GRAS Flavour Substances Lists GRAS 3-15 No.2001-3905 (as of 2000). This list contains natural and synthetic flavoring agents approved by the American public health authority, FDA, for use in foodstuffs: FDA Regulation 21 CFR 172.515 (Synthetic Flavoring Substances and Adjuvants) and FDA Regulation 21 CFR 182.20 (Natural Flavoring Substances and Adjuvants).

The flavor component (C) can contain

from 0.1 to 99.9% by weight, preferably from 0.5 to 99% by weight, of component (a);

from 0 to 25% by weight, preferably from 0.01 to 10% by weight, of component (b1); and/or

from 0 to 70% by weight, preferably from 0.01 to 30% by weight, of component (b2).

According to the invention, component (a) may contain one or more GRAS flavor alcohols. It is preferred according to the invention to use two or three GRAS flavor alcohols. In detail, the following GRAS flavor alcohols may be employed, for example: benzyl alcohol, acetoin (acetylmethylcarbinol), ethyl alcohol (ethanol), propyl alcohol (1-propanol), iso-propyl alcohol (2-propanol, isopropanol), propylene glycol, glycerol, n-butyl alcohol (n-propyl carbinol), iso-butyl alcohol (2-methyl-1-propanol), hexyl alcohol (hexanol), L-menthol, octyl alcohol (n-octanol), cinnamyl alcohol (3-phenyl-2-propene-1-ol), α-methylbenzyl alcohol (1-phenylethanol), heptyl alcohol (heptanol), n-amyl alcohol) (1-pentanol), iso-amyl alcohol (3-methyl-1-butanol), anisalcohol (4-methoxybenzyl alcohol, p-anisalcohol), citronellol, n-decyl alcohol (n-decanol), geraniol, β-γ-hexenol (3-hexenol), lauryl alcohol (dodecanol), linalool, nerolidol, nonadienol (2,6-nonadiene-1-ol), nonyl alcohol (nonanol-1), rhodinol, terpineol, borneol, clineol (eucalyptol), anisole, cuminyl alcohol (cuminol), 10-undecene-1-ol, 1-hexadecanol. As said derivatives, both natural and synthetic (naturally occurring or not) derivatives can be employed. Suitable derivatives include, for example, the esters, ethers and carbonates of the above mentioned GRAS flavor alcohols. Particularly preferred GRAS flavor alcohols are benzyl alcohol, 1-propanol, glycerol, propylene glycol, n-butyl alcohol, citronellol, hexanol, linalool, acetoin and their derivatives.

As component (b1), the following polyphenols may be employed: catechol, resorcinol, hydroquinone, phloroglucinol, pyrogallol, cyclohexane, usnic acid, acylpolyphenols, lignins, anthocyans, flavones, catechols, gallic acid derivatives (e.g., tannins, gallotannin, tannic acids, gallotannic acids), including derivatives of the above-mentioned compounds, such as 2,5-dihydroxyphenyl)carboxylic and (2,5-dihydroxyphenyl)alkylenecarboxylic substitutions, salts, esters, amides; caffeic acid and its esters and amides, flavonoids (e.g., flavone, flavonol, isoflavone, gossypetin, myricetin, robinetin, apigenin, morin, taxifolin, eriodictyol, naringin, rutin, hesperidin, troxerutin, chrysin, tangeritin, luteolin, catechols, quercetin, fisetin, kaempferol, galangin, rotenoids, aurones, flavonols, flavonediols), extracts, e.g. from Camellia, Primula. Further, their possible derivatives, e.g., salts, acids, esters, oxides and ethers, may also be used. A particularly preferred polyphenol is tannin (a GRAS compound).

As component (b2), the following GRAS acids may be used, for example: acetic acid, aconitic acid, adipic acid, formic acid, malic acid (1-hydroxysuccinic acid), capronic acid, hydrocinnamic acid (3-phenyl-1-propionic acid), pelargonic acid (nonanoic acid), lactic acid (2-hydroxypropionic acid), phenoxyacetic acid (glycolic acid phenyl ether), phenylacetic acid (α-toluenic acid), valeric acid (pentanoic acid), iso-valeric acid (3-methylbutyric acid), cinnamic acid (3-phenylpropenoic acid), citric acid, mandelic acid (hydroxyphenylacetic acid), tartaric acid (2,3-dihydroxybutanedioic acid; 2,3-dihydroxysuccinic acid), fumaric acid, tannic acid and their derivatives.

Suitable derivatives of the mentioned acids according to the present invention are esters (e.g., C₁₋₆-alkyl esters and benzyl esters), amides (including N-substituted amides) and salts (alkali, alkaline earth and ammonium salts). According to the present invention, the term “derivatives” also encompasses modification of the side-chain hydroxy functions (e.g., acyl and alkyl derivatives) and modifications of the double bonds (e.g., the perhydrogenated and hydroxylated derivatives of the mentioned acids).

The mixing ratio of component (a) to component (b) is preferably between 10,000:1 and 1:10,000, more preferably between 1000:1 and 1:1000, and even more preferably between 100:1 and 1:100.

In a preferred embodiment of the process according to the invention, the flavor component (C′) contains:

(a1) benzyl alcohol as a necessary component; and optionally

(a2) one or more further GRAS flavor alcohols or their derivatives; and

(b1) one or more polyphenol compounds; and/or

(b2) one or more GRAS acids or their derivatives.

Suitable amounts of components (a1), (a2), (b1) and (b2) are:

from 0.1 to 99% by weight, preferably from 0.1 to 75% by weight, of benzyl alcohol;

from 0 to 99.8% by weight, preferably from 0.01 to 99% by weight, of component (a2);

from 0 to 25% by weight, preferably from 0.01 to 10% by weight, of component (b1); and/or

from 0 to 70% by weight, preferably from 0.01 to 30% by weight, of component (b2).

The flavor component (C′) may further contain the following components (c) to (h), which are also flavoring agents recognized as GRAS (generally recognized as safe in food) in the FEMA/FDA GRAS Flavour Substances List 3-15 No. 2001-3905 (as of 2000).

As component (c), the following phenol compounds may be employed: thymol, methyleugenol, acetyleugenol, safrol, eugenol, isoeugenol, anethole, phenol, methylchavicol (estragol; 3-(4-methoxyphenyl)-1-propene), carvacrol, α-bisabolol, formesol, anisole (methoxybenzene), propenylguaethol (5-propenyl-2-ethoxyphenol) and their derivatives.

As GRAS esters (component (d)), allicin and the following acetates may be used: iso-amyl acetate (3-methyl-1-butyl acetate), benzyl acetate, benzylphenyl acetate, n-butyl acetate, cinnamyl acetate (3-phenylpropenyl acetate), citronellyl acetate, ethyl acetate (acetic ester), eugenol acetate (acetyleugenol), geranyl acetate, hexyl acetate (hexanyl ethanoate), hydrocinnamyl acetate (3-phenylpropyl acetate), linalyl acetate, octyl acetate, phenylethyl acetate, terpinyl acetate, triacetin (glyceryl triacetate), potassium acetate, sodium acetate, calcium acetate. Further suitable esters are the ester derivatives of the above defined acids (component (b2)).

As terpenes (component (e)), there may be used, for example, camphor, limonene and β-caryophyllene.

The acetals (component (f)) which can be used include, e.g., acetal, acetaldehyde dibutyl acetal, acetaldehyde dipropyl acetal, acetaldehyde phenethyl propyl acetal, cinnamic aldehyde ethylene glycol acetal, decanal dimethyl acetal, heptanal dimethyl acetal, heptanal glyceryl acetal and benzaldehyde propylene glycol acetal.

As aldehydes (component (g)), there may be used, e.g., acetaldehyde, anisaldehyde, benzaldehyde, iso-butyl aldehyde (methyl-1-propanal), citral, citronellal, n-capryllic aldehyde (n-decanal), ethylvanillin, furfural, heliotropin (piperonal), heptyl aldehyde (heptanal), hexyl aldehyde (hexanal), 2-hexenal (β-propyl-acrolein), hydrocinnamic aldehyde (3-phenyl-1-propanal), lauryl aldehyde (dodecanal), nonyl aldehyde (n-nonanal), octyl aldehyde (n-octanal), phenylacetaldehyde (1-oxo-2-phenylethane), propionaldehyde (propanal), vanillin, cinnamic aldehyde (3-phenylpropenal), perillaldehyde and cuminaldehyde.

The following essential oils and/or alcoholic or glycolic extracts or extracts obtained by CO₂ high-pressure processes from the mentioned plants (component (h)) can also be employed according to the invention:

(h1) oils or extracts having a high content of alcohols: melissa, coriander, cardamon, eucalyptus;

(h2) oils or extracts having a high content of aldehydes: Eucalyptus citriodora, cinnamon, lemon, lemon grass, melissa, citronella, lime, orange;

(h3) oils or extracts having a high content of phenols: origanum, thyme, rosemary, orange, clove, fennel, camphor, mandarin, anise, cascarilla, estragon and pimento;

(h4) oils or extracts having a high content of acetates: lavender;

(h5) oils or extracts having a high content of esters: mustard, onion, garlic;

(h6) oils or extracts having a high content of terpenes: pepper, bitter orange, caraway, dill, lemon, peppermint, nutmeg.

The proportion of components (c) to (h) in the flavor component (C) or (C′) is preferably smaller than or equal to 25% by weight, more preferably within a range of from 0.001 to 9% by weight. Preferred among the further GRAS flavoring agents are the phenols (c) and essential oils (h).

Particularly preferred according to the present invention is flavor component (C) or (C′) in which the antimicrobially active component exclusively consists of GRAS flavoring agents, i.e., which does not contain any “derivatives” of the GRAS flavoring agents. As an example of such a composition, there may be mentioned a mixture of benzyl alcohol, one or two of the above-mentioned GRAS flavor alcohols (a2) and tannin. Such a mixture preferably contains from 0.1 to 99.9% by weight, more preferably from 0.1 to 20% by weight, of benzyl alcohol, and from 0.01 to 10% by weight of tannin. Another example of a preferred composition is a mixture of 2 alcohols, a polyphenol (especially tannin) and an essential oil (especially a phenolic essential oil, component (h3)).

In addition to components (A) to (C), further compounds (D), such as alcohols (D1), emulsifiers (D2), stabilizers (D3), antioxidants (D4), preservatives (D5), solvents (D6), carriers (D7) etc., may additionally be employed. The proportion of components (D) in the odor-masking composition may be up to 99% by weight, is preferably smaller than 50% by weight, and is more preferably within a range of from 0.1 to 20% by weight.

According to the invention, the alcohols (D1) are monohydric or polyhydric alcohols having from 2 to 10 carbon atoms, preferably having from 2 to 7 carbon atoms, wherein the GRAS alcohols are excluded. Preferably, the GRAS flavor alcohols (a) and further alcohols (D1) are employed in such amounts that their mixing ratio is between 1000:1 and 1:1000, especially between 100:1 and 1:100, and more preferably between 10:1 and 1:10.

The carriers D7 are preferably polymeric compounds, such as propylene glycol etc.

In certain applications, for example, when the odor-masking composition is contacted with foodstuffs or employed in rooms where people live, it may be appropriate to employ systems which are free from ethanol and isopropanol, or free from harmful doses of ethanol and isopropanol, since these substances can be absorbed by foods, for example, and may also be inhaled by the people in the treated rooms. In addition, when such compounds are used, there may be danger of explosion.

The distributing/atomizing of the antimicrobial composition is effected by commercially available two-fluid nozzles or evaporation techniques. Devices designated for this purpose, such as a bubbler means, which applies disinfectant to the air in a superfine distribution and with the lowest possible dose, a device to be applied especially to the package and a wick system are depicted in the accompanying Figures.

The atomizing is effected by the continuous method described in PCT/EP 00/02992 for enriching air with an air-treatment agent (12), in which the air treatment agent (12) is introduced into the air in a liquid phase and evaporated, wherein the proportion of treatment agent in the air per m³ of air is between 0.1 and 0.00001 ml, preferably between 0.01 and 0.0001 ml, and using the device described here for enriching air with an air treatment agent (12), comprising:

a storage vessel (10) for liquid air treatment agent (12);

a vortexing chamber (16) to which liquid air-treatment agent (12) is supplied; and

a means (24) for producing a current of air in the vortexing chamber (16), so that turbulence occurs in the liquid air-treatment agent (12) due to the current of air (30, 34), and a mixture of air and vaporized air-treatment agent (12) exists from the vortexing chamber (16).

In these methods, the air-treatment agent is introduced into the air in a liquid phase and evaporated. With such low amounts of air treatment agents per m³ of air, a precipitate of the air treatment agent cannot be detected. Therefore, the method may also be employed for the treatment of air in storage rooms for food. Also in waiting rooms or apartments of allergic people and the like, the use of the method according to the invention is particularly advantageous because an annoying precipitate on cool windows or the like will not occur.

For a proportion of air treatment agent of as low as 15 ppt (parts per trillion), a reduction of offensive smells by 100% could already be detected in an experiment. The proportion of air treatment agent is preferably 100 ppt and more preferably 10 ppt.

Preferably, in the method for introducing the air treatment agent into the air, the air treatment agent is first supplied from a storage chamber to a vortexing chamber through which air is flowing. The amount of air supplied to the vortexing chamber and the amount of air treatment agent supplied to the vortexing chamber are adjusted to provide a proportion of air treatment agent of between 0.1 and 0.00001 ml, preferably between 0.01 and 0.0001 ml per m³ of air per hour. Subsequently, the mixture of air and vaporized air treatment agent is introduced into the space to be treated.

The evaporation of the air treatment agent occurs without the supply of heat. Exclusively due to the vortexing of the air treatment agent, uptake of the low amount of air treatment agent by the air is achieved. The amount of air treatment agent dragged away by the current of air is so low that an aerosol is not formed. The vortexing of the air treatment agent in the vortexing chamber generates a large number of air bubbles. This increases the surface of the air treatment agent in such a way that low amounts of air treatment agent are taken up by the current of air.

The amount of air supplied to the vortexing chamber and the amount of air treatment agent supplied to the vortexing chamber can be established empirically. Care is to be taken that the speed of the current of air is not so high that droplets of air treatment agent are dragged away. On the other hand, too low an amount of air treatment agent contained in the vortexing chamber causes that insufficient vortexing occurs. It has been found that particularly good results can be achieved at a ratio of the amount of air supplied to the amount of air treatment agent supplied of between 45%/55% and 30%/70%. Preferably, this ratio is between 42%/58% and 35%/65%.

Preferably, before being introduced into the space to be treated, the mixture of air and air treatment agent is conducted through an intermediate chamber which is separated from the vortexing chamber by a retaining disk. The function of the intermediate chamber is to allow excess air treatment agent in the air to condensate out. This is supported by the retaining disk, which preferably has fine apertures or is designed as a fine-pore membrane. Thus, the intermediate chamber serves as a drop separator. This ensures that no aerosol will get into the space to be treated. In the mixture of air and vaporized air treatment agent flowing into the space to be treated, a precipitate cannot be detected with conventional methods.

Since the amount of air treatment agent introduced into the vortexing chamber is significantly higher than the proportion of treatment agent contained in the mixture of air and air treatment agent, excess air treatment agent is discharged from the vortexing chamber. Preferably, the air treatment agent is recirculated into the storage chamber. From here, it can be reintroduced into the vortexing chamber immediately.

The device for enriching air with an air-treatment agent, which is particularly suitable for the disinfection of air, comprises a storage chamber, a vortexing chamber and a means for generating a current of air. The storage chamber contains a liquid air treatment agent. The liquid air treatment agent is supplied to the vortexing chamber, for example, using a pump. Depending on the configuration of the device, the means for generating a current of air can be a fan sucking the mixture out of the vortexing chamber, or a fan blowing air into the vortexing chamber. The fan is arranged in such a way that a current of air is generated in the vortexing chamber due to which the vortexing of the liquid treatment agent is effected. Due to the vortexing of the air treatment agent, the air takes up a small amount of air treatment agent, so that a mixture of air and vaporized air treatment agent exits from the vortexing chamber.

The device is suitable for performing the method according to the invention, so that the mixture of air and vaporized air treatment agent existing from the device has a proportion of air treatment agent per m³ of air per hour of between 0.1 and 0.00001 ml, preferably between 0.01 and 0.0001 ml. Depending on the kind of treatment agent, the proportion of the air treatment agent in the air can be adjusted by the ratio of the amount of air supplied to the amount of treatment agent supplied to the vortexing chamber. It has been found that such a low proportion of treatment agent can be achieved at a ratio of the amount of air to the amount of treatment agent of between 45%/55% and 30%/70%, preferably between 42%/58% and 35%/65%.

Preferably, the vortexing chamber has air inlets in the bottom region through which air flows into the vortexing chamber. Further, excess air treatment agent can drain from the vortexing chamber through the air inlets in a direction opposite to that of the air flow.

In experiments with an air disinfectant, a proportion of treatment agent of 0.01 ml per m³ of air was achieved at an air flow rate of about 1100 m³ per hour. Thus, with the above-mentioned ratios between the air and the treatment agent, a very low proportion of air treatment agent is taken up by the air, and a major portion of the air treatment agent is discharged from the vortexing chamber. This is a surprising effect, because a very low proportion of air treatment agent is taken up by the air due to the vortexing despite of the very large amount of air treatment agent present in the vortexing chamber. To introduce such low amounts of air treatment agent into the air is not possible with spraying techniques or with thermal evaporation. In particular, it is not possible when known devices are operated without pulsing. However, in the device according to the invention, the above result was achieved without any pulsing.

In order to ensure that actually no precipitating aerosol escapes from the device, an intermediate chamber is provided downstream of the vortexing chamber. Between the intermediate chamber and the vortexing chamber, a retaining disk is provided. Any droplets of air treatment agent dragged away by the current of air are retained by the retaining disk, on the one hand, and will condensate out in the intermediate chamber, on the other hand.

Preferably, filters are inserted upstream of the air inlets of the vortexing chamber in order to supply air to the device which is as much as possible, free of germs, particles and bacteria. For this purpose, a particle filter and/or a bacterial filter and/or a moisture filter are provided.

Advantageously, the device is coupled to an air conditioning system, so that a distribution of the air treatment agent throughout the space is ensured by the air conditioning system.

A pressure generating means can be provided downstream of the device to increase the pressure of the exiting mixture of air and vaporized air treatment agent. Such a device can be used, for example, to ensure that the mixture is blown also into the corners of a room.

To a device with a pressure generating means connected thereto, a lance with air outlets can be connected. The lance can be inserted into food packages in order to introduce the air treatment agent into the package.

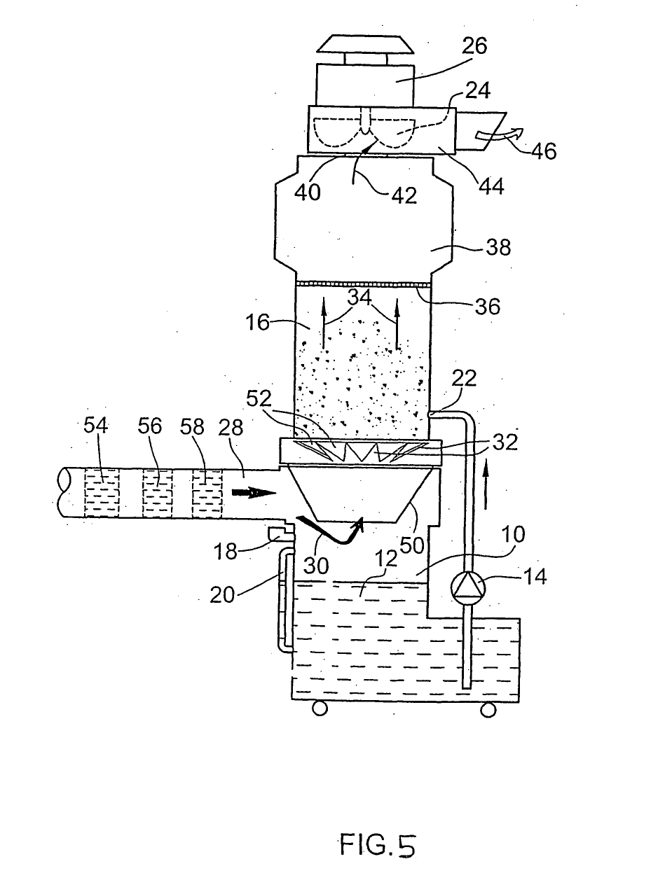

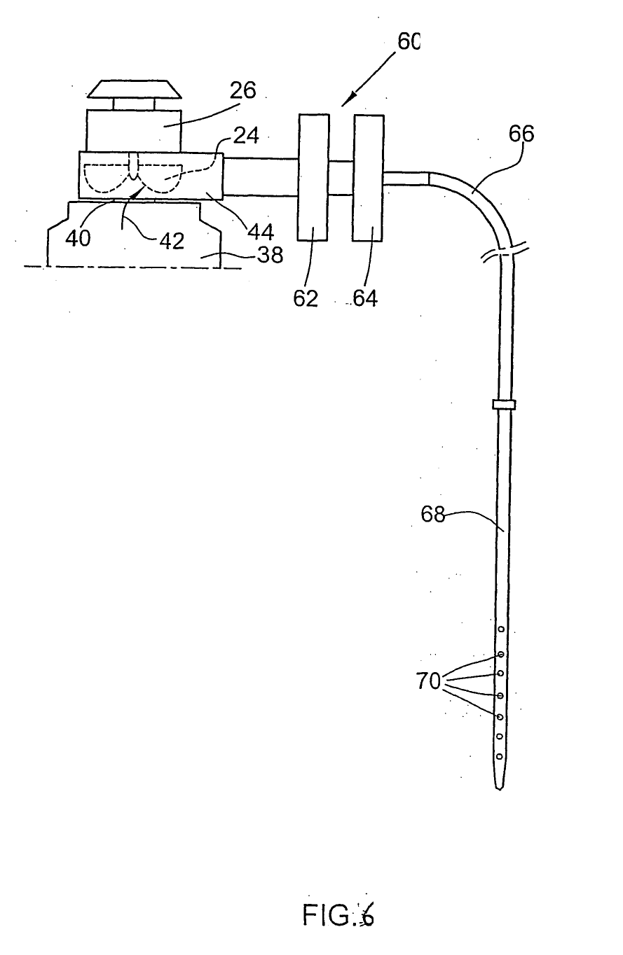

In the following, the devices shown in FIGS. 5 and 6 will be further illustrated, wherein:

A storage chamber 10 contains air treatment agent 12. The air treatment agent 12 is pumped from the storage chamber 10 into a vortexing chamber 16 using a pump 14. Further, the storage chamber 10 is provided with a filler neck 18 for replenishing air treatment agent 12 and with a level indicator 20 having the shape of a transparent tube.

The air treatment agent 12 pumped from the storage chamber 10 into the vortexing chamber 16 is supplied to the vortexing chamber 16 through an inlet 22. Depending on the pump pressure and the size of the inlet 22, the air treatment agent 12 is injected into the vortexing chamber 16 at different pressures. This injection of the air treatment agent 12 can increase the vortexing effect in the vortexing chamber 16.

Using a fan 24 serving as a means for generating a current of air and driven by a motor 26, air is sucked through an air supply duct 28 into the upper region of the storage chamber 10. From there, the air enters the vortexing chamber 16 in the direction of arrow 30 through air inlets 32 provided in the bottom region of the vortexing chamber 16. From there, the air current enters an intermediate chamber 38 in the direction of arrows 34 through a retaining disk 36. From the intermediate chamber 38, the mixture of air and air treatment agent enters a fan chamber 44 through a tubular connection piece 40 in the direction of arrow 42, and from there, it enters the space to be treated in the direction of arrow 46.

The air inlets 32 provided in the bottom region of the vortexing chamber 16 are radially arranged slots through which the air enters the vortexing chamber 16. Since the amount of air treatment agent 12 supplied to the vortexing chamber 16 is higher than the proportion of air treatment agent in the mixture exiting the device, a major portion of the air treatment agent 12 must be recirculated from the vortexing chamber 16 into storage chamber 10. In the embodiment shown, the excess air treatment agent 12 flows through the slot-shaped air inlets 32 back into the storage chamber 12. For this purpose, the bottom region of the vortexing chamber 16 in which the air inlets 32 are provided has a funnel-shaped design. In order to ensure a well-aimed backflow of the excess air treatment agent, a funnel 50 is provided in the upper region of the storage chamber 10. Further, the funnel 50 prevents air treatment agent 12 from getting into the air supply duct 28.

The slot width of the air inlets 32 can be adjusted because the bottom region consists of individual triangular segments 52 whose inclination angle can be adjusted. The steeper the segments 52 are arranged, the larger are the slot-shaped air inlets 32.

The mixture of air and air treatment agent exiting from the vortexing chamber 16 is conducted through the retaining disk 36 into the intermediate chamber 38. The retaining disk 36 has apertures of low diameter or consists of a membrane having a fine porosity. The retaining disk 36 retains any droplets of air treatment agent dragged away by the current of air, so that only vaporized air treatment agent gets into the intermediate chamber 38, if possible.

The intermediate chamber 38 is provided as an additional safeguard. It ensures that any air treatment agent present in the mixture of air and air treatment agent which is not in a vaporized form will condensate out in the intermediate chamber 38. The portion of the air treatment agent which condensates out on the walls of the intermediate chamber 38 flows through the retaining disk 36 back into the vortexing chamber 16. From the intermediate chamber 38, a mixture of air and vaporized air treatment agent exclusively enters the fan chamber 44 along the arrow 42. The mixture entering the fan chamber 44 does not contain any more aerosol, so that the small amount of air treatment agent present in the mixture can no longer be detected as a precipitate.

In the air supply duct 28, a particle filter 54, especially a pollen filter, a bacterial filter 56 and a moisture filter 58, is provided for filtering the air sucked in. The moisture filter 58 withdraws the moisture from the air sucked in because the air treatment agents used are often hygroscopic.

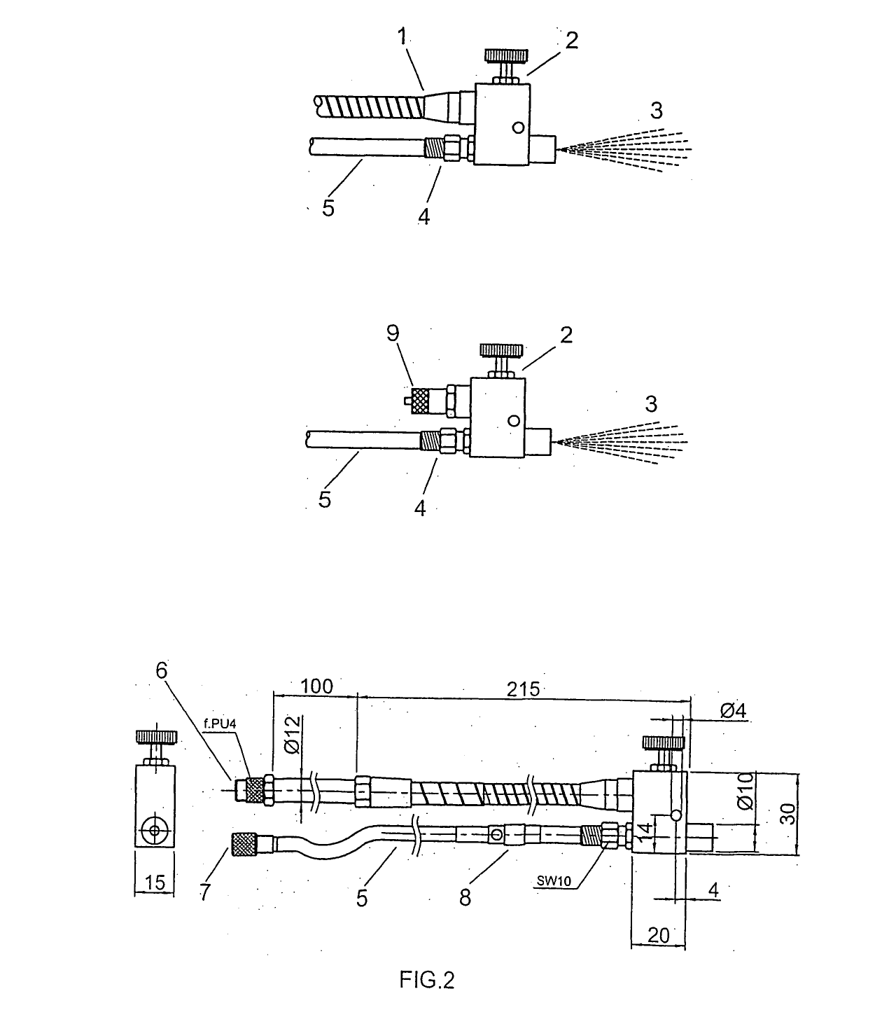

To the fan chamber 44, a pressure generating means 60 (FIG. 2) can be connected. In the example shown, this is a two-step pressure generating means having a first pressure generating step 62 and a second pressure generating step 64. After the pressure generating means 60, the mixture of air and air treatment agent is introduced into a flexible tube 66 under increased pressure. To the flexible tube 66, a lance 68 without outlets 70 is connected. The lance 68 can be inserted into food packages to fill them with the mixture of air and air treatment agent.

The atomizing may also be effected by a discontinuous method, as described in a parallel German Utility Model Application (internal docket number 003220de).

In the method according to the invention, the atomizing/distributing is effected in such a way that the concentration of the odor-masking composition is from 0.001 to 1 ml per m³ of air, especially from 0.01 to 0.1 ml per m³ of air. With exchanging air systems in which an hourly recirculation is effected, the method is to be adjusted to provide a dosage of from 0.00001 to 1 ml per m³ of air, especially from 0.002 to 0.02 ml per m³ per hour.

Thus, the present method is suitable for the reduction of offensive smells in the air in private households, offices and public buildings as well as in food-processing plants, transport devices, cooling, air-conditioning and other aeration fields. In particular, by using antimicrobial flavor components, a disinfection of the ambient air is additionally achieved, which further increases the efficiency of the odor-reduction method.

The present invention will be illustrated in more detail by the following Examples.

### EXAMPLES

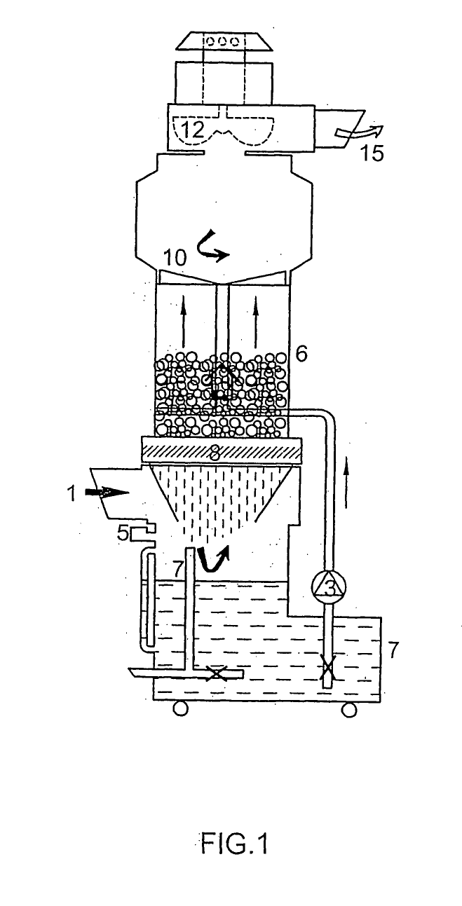

Apparatus employed: For the Examples described below, the devices depicted in FIGS. 1 to 7 were used.

FIG. 1: Air DOA (disinfection of air) bubbler

Autonomous, permanently installed or mobile bubbler unit with incorporated exhaust fan and pump. Air quantity: 2 to 1600 m³/h (or larger).

Principle of function: Bubbler with floating DOA fluidized bed

Air with counter-current DOA agent. The DOA agent is caused to float in a chamber with a highly reduced pressure. This generates an equilibrium between the reduced pressure of the air and the DOA average weight. The air is distributed over the entire DOA surface and rises through the DOA bed in the form of microscopically sized bubbles. The air bubbles form a very large contact area between the gas and the liquid. The air pressure and dwelling time are in a well-balanced proportion. The DOA agent is transported along with the air in a corresponding dosage.

Fan: The exhaust radial fan is always positioned in the clean air zone and may also be installed externally.

Bubbler: The washer consists of:

absorption liquid container

washing chamber

drying chamber

fan

Legend for FIG. 1:

1) air suction piece with/without microfilter

2) DOA agent supply

3) e.g., pump 15 m³/h motor 220/380 V; 2800 rpm; 1.1 kW

5) dosing unit (electric) quantity/air ratio DOA agent dosing 0.02 ml to 0.1 ml/m³

(h) dosage

6) DOA agent

7) DOA agent

9) washing chamber

10) dryer

12) fan 1200/1800 m³/h motor 220/380 V; 2800 rpm; 1.1 kW

15) exhaust piece, e.g., diameter 200 mm

FIG. 2: DOA atomizer low pressure system (for thin liquids)

For atomizing thin oils and liquids with a well-aimed field of activity.

The atomizer responds already from a pressure of 2 bar gauge.

With the flexible metal tube, the atomizer can be rotated and turned as desired, and attached at any place using the magnetic holder.

Function: When compressed air is applied, atomizing occurs immediately (a built-in check valve prevents the liquid level in the flexible tube from dropping). The atomizer works permanently, or intermittently with the automatic blowing device, but always in well-dosed quantities. In the center of the air jet, the liquid is economically and cleanly supplied. Through the air and liquid throttle, the amount of air and liquid can be finely adjusted. The atomizer can be continuously adjusted at a spraying angle of from 10° to 30°.

Legend for FIG. 2:

1) flexible metal tube, nickel-coated

2) air throttle

3) spraying angle 10°-30°

4) liquid throttle

5) PVC flexible tube 1 m

6) connection for PK4

7) screen valve

8) check valve

9) connection for compressed air

10) throttle ball (not visible)

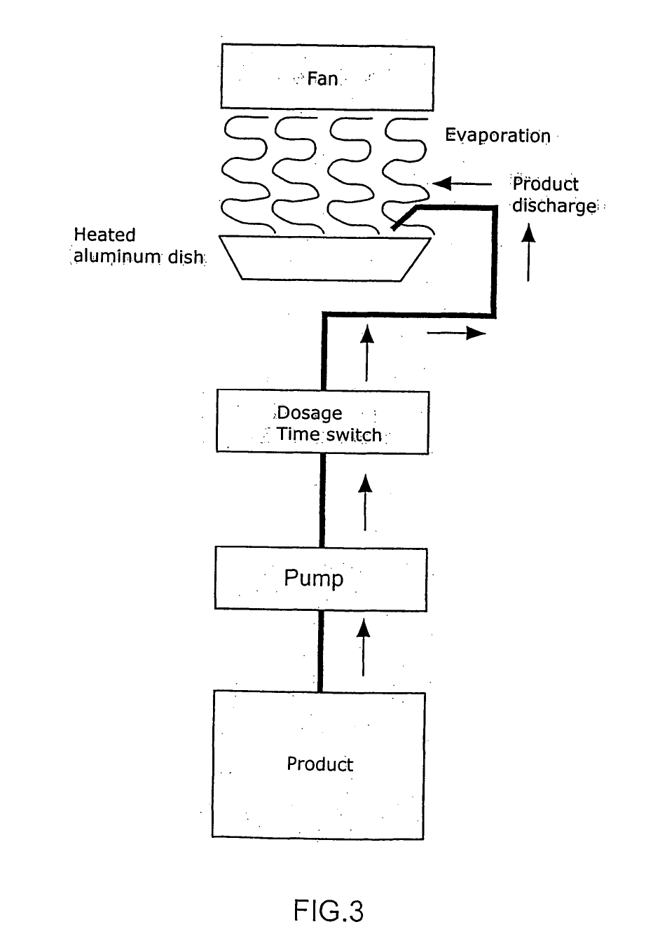

FIG. 3: DOA evaporation system

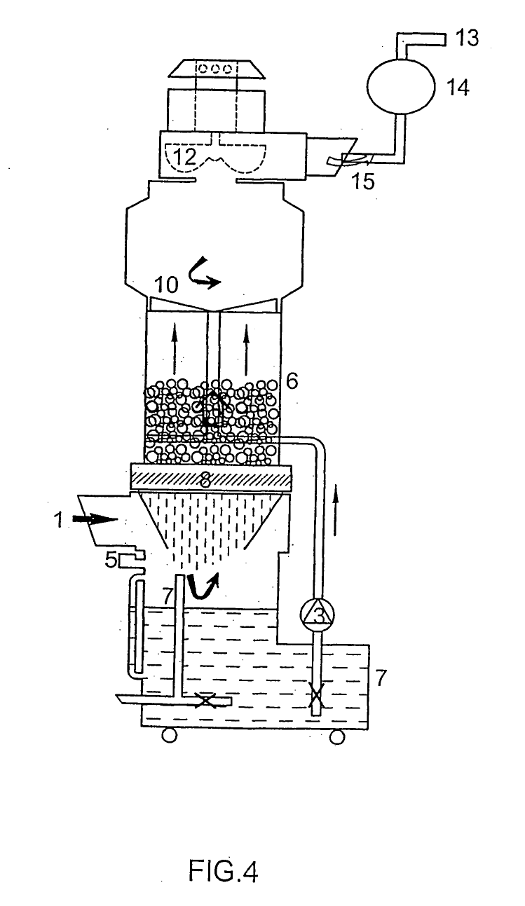

FIG. 4: DOA disinfection in a package with bubbler

Fan: The exhaust radial fan is always positioned in the clean air zone and may also be installed externally.

Legend for FIG. 4:

1) air and/or CO/or nitrogen or the like suction piece with/without microfilter

2) DOA agent supply

3) pump 15 m³/h motor 220/380 V; 2800 rpm; 1.1 kW

5) dosing unit (electric) quantity/air ratio DOA agent dosing 0.02 ml to 0.1 ml/m³

(h) dosage

6) DOA agent

7) DOA agent

9) washing chamber

10) dryer

12) fan 1200/1800 m³/h motor 220/380 V; 2800 rpm; 1.1 kW

13) discharge into package (e.g., via lance)

14) pressure reservoir (about 2 to 8 bar compressed) consisting of air and CO₂ and N₂ and DOA agent with low moisture

15) exhaust piece, e.g., diameter 200 mm

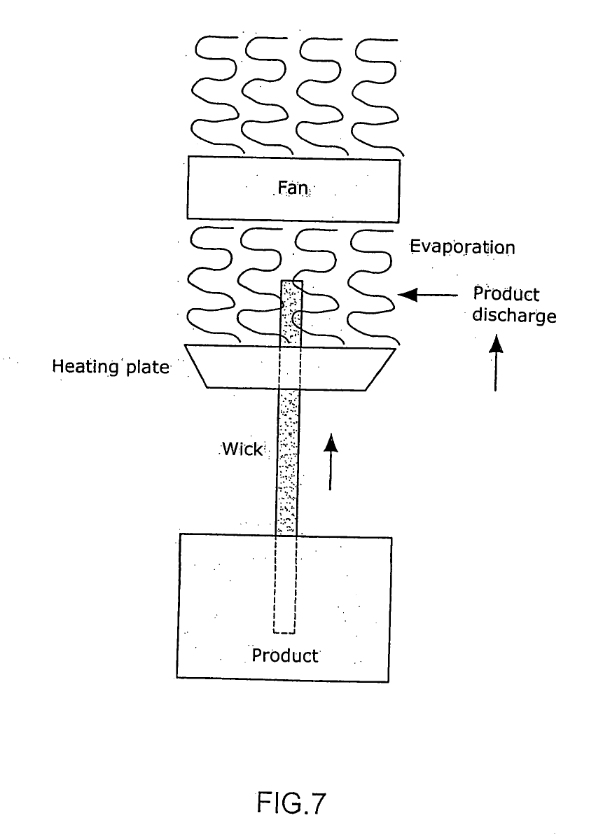

FIG. 7: DOA-wick system with a heating plate and fan

### Example 1

### Examination of the Odor Reduction Using the Device Represented in FIG. 1

The disinfecting agent consisting of 1% by weight of polyphenol (tannin), 3% by weight of benzyl alcohol, 0.1% by weight of essential oil (phenolic) and 90.9% by weight of propylene glycol was admixed with 5% by weight of polyvinylpyrrolidone (pharmacopoeias: Ph. Eur//USP/NF//JP/JPE, viscosity (20% by weight in water) 20 mPa·s, molecular weight 35,000 to 50,000), and the mixture was charged into the dosage device of the air-DOA bubbler according to FIG. 1 as a processing agent.

A closed room of 12.18 m² with a standard ceiling height without exhaust/aeration was contaminated with cigar ashes from used cigar stubs (34.39 g) in such a way that the amount was distributed to four Petri dishes on the floor in corners of the room. The time of action until the offensive smell of cigar ashes was optimized was 24 h at 25° C. (closed).

On the same day, the bubbler device was already introduced without operating it in order to avoid alteration of the air later. On the next day (time of action: 24 h), after a positive odor evaluation (“intensive cigar smell”), the bubbler was operated for 24 h at a dosage of the agent of 0.00159 g/m³ per hour.

After 24 hours, the room was opened. It was free of smell and also germ-free from biological air-germ sampling. Experiments with the same dosages and conditions of the odor-neutralizing agent for air (polyvinylpyrrolidone), 5% by weight and 100% by weight in water and/or propylene glycol (without disinfectant) provided the same odor-neutralization results.

1. A method for non-toxic odor reduction, comprising the distributing or atomizing of an odor-masking composition in the environment to be treated, wherein said odor-masking composition contains at least one odor-masking component (A) selected from terpenes, corn starch, manganese salts, essential oils and polyvinylpyrrolidone.

2. The method according to claim 1, wherein said odor-masking component (A) contains at least polyvinylpyrrolidone.

3. The method according to claim 2, wherein said polyvinylpyrrolidone has a molecular weight of from 10,000 to 60,000, preferably from 30,000 to 50,000.

4. The method according to one or more of claims 1 to 3, wherein the proportion of said odor-masking component (A) is from 0.001 to 50% by weight, preferably from 0.1 to 20% by weight, of the odor-masking composition.

5. The method according to one or more of claims 1 to 4, wherein said odor-masking composition further contains a functional flavor component (B).

6. The method according to claim 5, wherein said functional flavor component (B) contains one, preferably more, of the following substances:
hexyl butyrate, octyl acetate, isobutyl isobutyrate, cis-3-hexene-1-yl acetate, γ-decalactone, ethyl caproate, butyl acetate, ethyl benzoate, ethyl butyrate, hexyl acetate, methyl caproate, phenylethyl alcohol, citronellol, undecyl aldehyde, benzylphenyl acetate, cinnamyl alcohol, eugenol, benzyl acetate, linalool, cis-jasmone, acetylmethyl anthranilate, cis-3-hexene-1-ol, cis-3-hexene-1-yl salicylate, methyl benzoate, methyl salicylate, geranyl acetate, cis-3-hexene-1-yl acetate, Litsea cubeba, orange oil, phenylpropyl alcohol and phenylethyl acetate.

7. The method according to claim 6, wherein the proportion of said functional flavor component (B) is from 0.001 to 20% by weight, preferably from 0.1 to 5% by weight, of said odor-masking composition.

8. The method according to one or more of claims 1 to 7, wherein said odor-masking composition further contains a flavor component (C) selected from essential oils, flavoring agents and fragrances.

9. The method according to claim 8, wherein the proportion of said flavor component (C) in said odor-masking composition is from 0.001 to 95% by weight, preferably from 0.1 to 80% by weight.

10. The method according to claim 8 or 9, wherein said flavor component (C) contains at least one GRAS (generally recognized as safe) flavoring agent, preferably an aromatic GRAS flavor alcohol, especially benzyl alcohol, and/or a GRAS polyphenol compound.

11. The method according to claim 8 or 9, wherein said flavor component (c) contains at least two GRAS flavoring agents.

12. The method according to claim 11, wherein said flavor component (C) contains:
(a) one or more GRAS flavor alcohols or their derivatives; and
(b) one or more flavoring agents selected from
(b1) polyphenol compounds; and
(b2) GRAS flavor acids or their derivatives.

13. The method according to claim 11, wherein said flavor component (C) contains:
from 0.1 to 99% by weight, preferably from 0.5 to 99% by weight, of component (a);
from 0 to 25% by weight, preferably from 0.01 to 10% by weight, of component (b1); and
from 0 to 70% by weight, preferably from 0.01 to 30% by weight, of component (b2).

14. The method according to claim 12 or 13, wherein said GRAS flavor alcohol (a) is selected from:
benzyl alcohol, acetoin, ethyl alcohol, propyl alcohol, iso-propyl alcohol, propylene glycol, glycerol, n-butyl alcohol, iso-butyl alcohol, hexyl alcohol, L-menthol, octyl alcohol, cinnamyl alcohol, α-methylbenzyl alcohol, heptyl alcohol, n-amyl alcohol, isoamyl alcohol, anisalcohol, citronellol, n-decyl alcohol, geraniol, β-γ-hexenol, lauryl alcohol, linalool, nerolidol, nonadienol, nonyl alcohol, rhodinol, terpineol, borneol, clineol, anisole, cuminyl alcohol, 10-undecene-1-ol, 1-hexadecanol, or their derivatives;
said polyphenol compound (b1) is selected from:
catechol, resorcinol, hydroquinone, phloroglucinol, pyrogallol, cyclohexane, usnic acid, acylpolyphenols, lignins, anthocyans, flavones, catechols, gallic acid derivatives, caffeic acid, flavonoids, derivatives of the mentioned polyphenols, and extracts from Camellia, Primula; and
said GRAS acid (b2) is selected from:
acetic acid, aconitic acid, adipic acid, formic acid, malic acid, capronic acid, hydrocinnamic acid, pelargonic acid, lactic acid, phenoxyacetic acid, phenylacetic acid, valeric acid, iso-valeric acid, cinnamic acid, citric acid, mandelic acid, tartaric acid, fumaric acid, tannic acid and their derivatives.

15. The method according to one or more of claims 11 to 14, wherein said flavor component contains:
(a1) an aromatic GRAS alcohol, especially benzyl alcohol, as a necessary component; and optionally
(a2) one or more further GRAS flavor alcohols or their derivatives; and
(b1) one or more polyphenol compounds; and/or
(b2) one or more GRAS acids or their derivatives.

16. The method according to claim 15, wherein said flavor component contains:
from 0.1 to 99% by weight, preferably from 0.1 to 75% by weight, of benzyl alcohol;
from 0 to 99.8% by weight, preferably from 0.01 to 99% by weight, of component (a2); and
from 0 to 25% by weight, preferably from 0.01 to 10% by weight, of component (b1);
from 0 to 70% by weight, preferably from 0.1 to 30% by weight, of component (b2).

17. The method according to one or more of claims 11 to 16, wherein said flavor component contains further GRAS flavoring agents selected from (c) phenols, (d) esters, (e) terpenes, (f) acetals, (g) aldehydes and (h) essential oils.

18. The method according to claim 17, wherein said flavor component contains from 0.001 to 25% by weight, preferably from 0.01 to 9% by weight, of said further GRAS flavoring agents (c) to (h).

19. The method according to claim 17 or 18, wherein said further GRAS flavor agents are phenols (c) and/or essential oils (h).

20. The method according to one or more of claims 11 to 19, wherein said flavor component does not contain any derivatives of the GRAS flavoring agents.

21. The method according to one or more of claims 15 to 20, wherein said flavor component contains one or two GRAS flavor alcohols (a2) and at least one polyphenol compound (b1).

22. The method according to claim 21, wherein said polyphenol compound (b1) is tannin.

23. The method according to claim 22, wherein said flavor component contains from 0.1 to 20% by weight of benzyl alcohol and from 0.01 to 10% by weight of tannin.

24. The method according to one or more of claims 11 to 23, wherein said composition further contains monohydric or polyhydric alcohols having from 2 to 10 carbon atoms, emulsifiers, stabilizers, antioxidants, preservatives, solvents and/or carriers.

25. The method according to one or more of claims 11 to 25, wherein said atomizing of said odor-masking composition in the air is effected by a two-fluid nozzle system, evaporation system, bubbler device or wick system.

26. The method according to claim 25, wherein the proportion of odor-masking composition in the mixture of air and odor-masking composition supplied to the environment to be treated is 100 ppt, preferably 10 ppt.

27. The method according to claim 25, wherein a dosage of from 0.000001 to 1 ml per m³ of air per hour, preferably from 0.001 to 0.1 ml per m³ of air per hour, is achieved by said distributing or atomizing of said odor-masking composition.

28. An odor-masking composition for non-toxic odor reduction as defined in claims 1 to 24.

29. Use of an odor-masking composition as defined in claim 28 for non-toxic odor reduction.
